(19) United States
(12) Patent Application Publication
(10) Pub. No.: US 2018/0252613 A1
(43) Pub. Date: Sep. 6, 2018

(54) Leak Detection Upon Evacuation of a Test Chamber or a Specimen

(71) Applicant: INFICON GmbH, Koeln (DE)

(72) Inventors: Jochen Puchalla-König, Bergheim (DE); Ludolf Gerdau, Elsdorf (DE)

(73) Assignee: INFICON GMBH, Koln (DE)

(21) Appl. No.: 15/760,014

(22) PCT Filed: Sep. 12, 2016
(86) PCT No.: PCT/EP2016/071416

§ 371 Date: Mar. 14, 2018

(30) Foreign Application Priority Data
Sep. 15, 2015 (DE) 10 2015 217 598.7

(51) Int. Cl. G01M 3/32

(52) U.S. Cl. CPC G01M 3/3236

(57) ABSTRACT

Method for detecting a leak in a specimen contained in a test chamber, the method comprising the following steps: positioning the specimen in the test chamber, evacuating the test chamber, measuring the partial pressure in the test chamber as a measuring signal M during the evacuation of the test chamber, forming a difference D from the progress of the signal M^{(t)} over time t and a fitting function F^{(t)} including the term t⁻ⁿ, where n is a positive rational number, and judging the presence of a leak in the specimen based on the differential signal D.

The invention relates to a method for detecting a leak in a specimen.

In testing for the presence of leaks in specimens, such as heat exchangers, it is known to place the specimen in a test chamber to be evacuated. The test chamber is evacuated so that a vacuum pressure prevails in the test chamber in the area outside the specimen, whereas a pressure approximately corresponding to atmospheric pressure prevails outside the test chamber and inside the specimen. Here, the specimen may be filled with a test gas. In case of a leak the gas contained in the specimen flows through the leak into the vacuum of the test chamber, where it causes a measurable increase in the partial pressure of the gas. Therefore, the development of the partial pressure of the gas inside the evacuated test chamber is measured and the leakage rate is calculated therefrom.

In an alternative test method the specimen is evacuated and subjected to a surrounding atmosphere containing a test gas, so that the test gas enters into the specimen through a possible leak. For leak detection, the partial pressure of the test gas inside the specimen is measured.

Conventionally, leak detection has to be postponed until the leakage rate signal measured by the leak detector device, i.e. the partial pressure of the gas in the test chamber or in the specimen, is sufficiently low and sufficiently stable. Only then is it possible to detect slight increases in the partial pressure of the gas, caused by leaks in the specimen, in the evacuated test chamber or in the evacuated specimen. The measured leakage rate signal of the leak detector device is thus composed of two components, namely the gas proportions entering into the test chamber or the specimen through a possible leak, and all other gases contained in the test chamber or the specimen, e.g. residual air still contained therein or gas proportions diffused or desorbed from the chamber walls or the specimen walls. The proportion of this background signal in the measuring signal must therefore be sufficiently small and sufficiently stable in order to be able to detect a possible leak in the specimen at all.

It is an object of the invention to allow an improved and faster detection of a leak in a specimen.

The method of the present invention is defined by the features of claim 1 or 2.

According thereto, after the specimen has been positioned in the test chamber, the partial pressure of the gas in the test chamber is measured as a measuring signal M in the area outside the specimen. From the development of the measuring signal M^{(t)} over time t and a fitting function F^{(t)}, the difference D^{(t)}=M^{(t)}−F^{(t)} is obtained. The fitting function F^{(t)} includes the term t⁻ⁿ, where n is a positive rational number. In particular, n is not a negative rational number and is not 0. A judgment on the presence of a leak in the specimen is then made with reference to the differential signal D, i.e. with consideration to the fitting function F and in particular already during the evacuation of the test chamber.

The method of the present invention may also be used in an analogous manner, if the specimen is evacuated, where the measuring signal M is the partial pressure of the gas inside the specimen during the evacuation thereof.

Using the fitting function F, that portion of the measuring signal is estimated that corresponds to the background signal and thus does not result from a leak in the specimen. The fitting function can in particular represent gas proportions in the measuring signal that result from diffusion and/or desorption from the walls of the test chamber or the specimen. These effects typically appear already at a pressure below one millibar and in particular below 0.1 millibar. Using the fitting function, the method of the present invention allows a meaningful judgment on the presence of a leak already during the evacuation of the test chamber at pressures of up to one millibar and with the background signal decreasing strongly.

Preferably n is a number greater than or equal to 1, where n is preferred to be a positive integer and in particular not a negative integer or 0. A particularly preferred case is n=2, so that the fitting function F^{(t)} includes the term

$${t}^{- 2} = \frac{1}{{t}^{2}} .$$

This term of the fitting function represents the gas proportions desorbed from the wall materials of the test chamber, in particular the plastic materials (seals). When evacuating the test chamber or the specimen, gases initially contained in the test chamber or the specimen, typically air, are pumped off first. When the pressure falls below a defined level, gas proportions begin to diffuse from the surfaces of the test chamber walls or the specimen walls. Diffusion typically originates from metal surfaces and decreases at a rate of 1/t, i.e. the reciprocal value of time t. The gas proportions that have gotten into the test chamber or the specimen through desorption decrease at a rate of about 1/t² over time t. Therefore, according to one embodiment, it is advantageous if the fitting function includes the term 1/t².

The fitting function F may in particular be F(t)=1/(c+a·t)², where both a and c are constant numbers.

Advantageously the fitting function F^{(t)} is calculated for a predetermined period of time. This period of time may be in a range between about 1 and 5 seconds and preferably is about two seconds. Advantageously the period of time ends at the moment of the respective current measurement.

It is further advantageous if the fitting function is calculated for each new measuring value as the differential signal D^{(t)} is less than e.g. one thousandth of the measuring signal M^{(t)}.

A judgment on the presence of a leak in a specimen based on the differential signal D can be made as soon as the test chamber pressure or the specimen pressure has fallen below one millibar and preferably below about 0.1 millibar.

A leak may be considered as having been detected when the differential signal exceeds a threshold value of one hundredth of the measuring signal M(t).

The following is a detailed explanation of an embodiment of the invention with reference to the Figures. In the Figures:

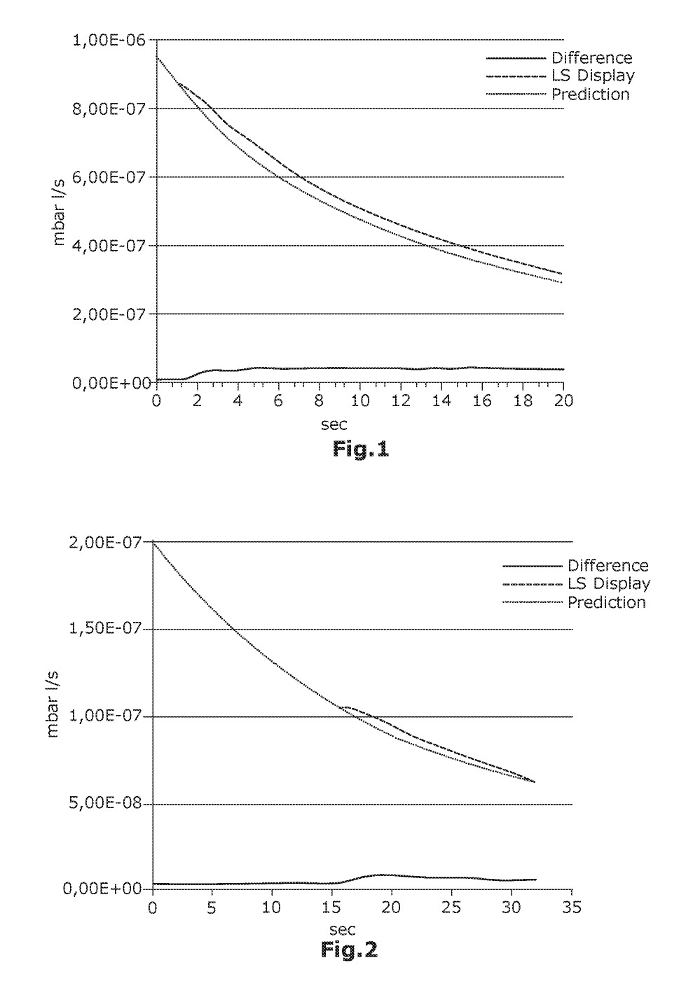

FIG. 1 shows the signal progress obtained in case of a stainless steel barrel, and

FIG. 2 shows the signal progress obtained in case of a plastic material barrel.

FIG. 1 shows the signal progress obtained upon the evacuation of a 10 liter barrel used as a specimen. The dashed line represents the measuring signal M(t) of the measured leakage rate in millibar by liters per second over time in seconds. The dotted line illustrates the fitting function F^{(t)} including the term

$$\frac{1}{{t}^{2}} .$$

The fitting function represents the background signal decreasing at a rate of

$$\frac{1}{{t}^{2}}$$

during evacuation. The differential signal D^{(t)}=M^{(t)}−F^{(t)} is represented by a solid line. The differential signal corresponds to the signal actually resulting from a leak in the specimen.

A leak of about

$$3 \cdot {10}^{- 8} \frac{mbar \cdot l}{s}$$

can be measured against a strongly decreasing background of about

$$9 \cdot {10}^{- 7} \frac{mbar \cdot l}{s} .$$

Here, the signal decreases by about 7.5·10⁻⁸ mbar l/s, i.e. by more than twice the measured leak.

FIG. 2 illustrates the case of an evacuation of a specimen in the form of a 10 liter plastic material barrel. A leak with a leakage rate of about

$$3 \cdot {10}^{- 9} \frac{mbar \cdot l}{s}$$

can be detected against a strongly decreasing background signal (by about 5.10⁻⁹ mbar l/s) at about

$$1 \cdot {10}^{- 7} \frac{mbar \cdot l}{s} .$$

1. A method for detecting a leak in a specimen contained in a test chamber, the method comprising the following steps:
positioning the specimen in the test chamber;
evacuating the test chamber;
measuring a partial pressure of gas within the test chamber as a measuring signal M during the evacuation of the test chamber;
forming a differential signal D between a progress of the measuring signal M(t) over time t and a fitting function F(t) including a term t⁻ⁿ, where n is a positive rational number; and
judging a presence of a leak in the specimen based on the differential signal D.

2. A method for detecting a leak in a specimen, the method comprising the following steps:
evacuating the specimen;
measuring a partial pressure in the specimen as a measuring signal M during the evacuation of the specimen;
forming a differential signal D between a progress of the measuring signal M(t) over time t and a fitting function F(t) including a term t⁻ⁿ, where n is a positive rational number; and
judging a presence of a leak in the specimen based on the differential signal D.

3. The method of claim 1, wherein n is greater than or equal to 1.

4. The method of claim 3, wherein n=2, so that the fitting function F(t) includes the term 1/t².

5. The method of claim 1, wherein the fitting function is
$$F ( t ) = \frac{1}{{( c + a \cdot t )}^{2}} ,$$
where both a and c are constant numbers.

6. The method of claim 1, wherein the fitting function F(t) is calculated for a predetermined period during the measurement.

7. The method of claim 6, wherein the period is in the range from about 1 to 5 seconds.

8. The method of claim 1, wherein the fitting function is calculated for a new measuring value as long as D(t)<M(t)/1000.

9. The method of claim 1, wherein the judging of the presence of a leak in the specimen is made based on the differential signal D, if a pressure in the test chamber is less than 1 mbar.

10. The method of claim 1, wherein a leak in the specimen is considered as being detected as soon as the differential signal D is greater than M(t)/100.

11. The method of claim 3, wherein n is an integer.

12. The method of claim 7, wherein the period is about 2 seconds.

13. The method of claim 9, wherein the judging of the presence of a leak in the specimen is based on the differential signal D, if a pressure in the test chamber is less than 0.1 mbar.
